(19) United States
(12) Patent Application Publication
(10) Pub. No.: US 2013/0301841 A1
(43) Pub. Date: Nov. 14, 2013

(54) AUDIO PROCESSING DEVICE, AUDIO PROCESSING METHOD AND PROGRAM

(71) Applicant: SONY CORPORATION, Tokyo (JP)

(72) Inventors: Yohei Sakuraba, Kanagawa (JP); Yasuhiko Kato, Kanagawa (JP); Nobuyuki Kihara, Tokyo (JP); Takeshi Yamaguchi, Kanagawa (JP)

(73) Assignee: Sony Corporation, Tokyo (JP)

(21) Appl. No.: 13/836,217

(22) Filed: Mar. 15, 2013

(30) Foreign Application Priority Data
May 9, 2012 (JP) 2012-107856

(51) Int. Cl. H04R 3/00

(52) U.S. Cl. CPC H04R 3/002
USPC 381/66

(57) ABSTRACT

An audio processing device includes: a directivity adjustment unit adjusting directivity and sharpness thereof in audio picked up by plural microphones picking up audio; and a howling suppression adjustment unit adjusting intensity of suppressing howling of audio picked up by the plural microphones, wherein the directivity adjustment unit adjusts the directivity and sharpness thereof in preference to the howling suppression of audio performed by the howling suppression adjustment unit.

### FIELD

The present disclosure relates to an audio processing device, an audio processing method and a program, and particularly relates to an audio processing device, an audio processing method and a program capable of reducing deterioration of tone quality while suppressing howling occurring when using a microphone and a speaker.

### BACKGROUND

When picking up audio by using a microphone and amplifying the picked up audio to be outputted from a speaker, howling may occur. The howling is a phenomenon in which cyclic uncomfortable sound is outputted from the speaker when audio outputted from the speaker is picked up by the microphone and amplification is repeated.

As a common coping method for suppressing the howling, whether the howling occurs or not is measured in advance while adjusting output from the speaker in a state where the microphone and the speaker are installed (refer JP-A-8-223684 (Patent Document 1)), and a notch filter is set in a frequency band in which howling occurs. It is also preferable to reduce the gain in the frequency band in which howling occurs by using, for example, a graphic equalizer instead of using the notch filter. Various types of devices executing processing of suppressing the howling by using various types of methods, namely, howling suppressors have been proposed (refer to JP-A-3-237889 (Patent Document 2)).

It is known that, when an omnidirectional microphone is used, the possibility of occurrence of howling is increased as audio outputted from the speaker which goes around and enters the microphone is increased. Accordingly, a directional microphone is generally applied, avoiding the omnidirectional one.

### SUMMARY

It is possible to eliminate or reduce the howling by applying the above-described howling suppressor also when using the omnidirectional microphone, however, the gain in the frequency band in which the howling occurs is largely reduced by the howling suppressor, which may reduce tone quality.

Accordingly, as a countermeasure against the howling, first, it is general that the reduction of the gain in the frequency band in which the howling occurs due to the howling suppressor is suppressed as small as possible by using the directional microphone.

However, tone quality of the omnidirectional microphone is generally preferable for recording or amplifying performance of musical instruments, therefore, there are many requests for using the omnidirectional microphone in order to give preference to tone quality. Even so, it is necessary to adopt the directional microphone and the howling suppressor for suppressing the howling, it is virtually difficult to maintain preferable tone quality when using the microphone and the speaker in the recording and amplification of the performance of musical instruments.

In view of the above, it is desirable to reduce the deterioration of tone quality while suppressing howling even in the configuration of using the directional microphone and the howling suppressor which are fundamental.

An embodiment of the present disclosure is directed to an audio processing device including a directivity adjustment unit adjusting directivity and sharpness thereof in audio picked up by plural microphones picking up audio, and a howling suppression adjustment unit adjusting intensity of suppressing howling of audio picked up by the plural microphones, in which the directivity adjustment unit adjusts the directivity and sharpness thereof in preference to the howling suppression of audio performed by the howling suppression adjustment unit.

The audio processing device may further include a howling index calculation unit calculating a howling index indicating an index of howling occurring due to audio picked up by the plural microphones, in which the directivity adjustment unit is allowed to adjust directivity and sharpness thereof in audio picked up by the plural microphones picking up audio based on the howling index, and the howling suppression adjustment unit is allowed to adjust intensity of suppressing howling of audio picked up by the plural microphones based on the howling index.

The audio processing device may further includes a band division unit dividing a band of audio picked up by the microphones, in which the howling suppression adjustment unit is allowed to calculate the howling index indicating the index of howling occurring due to audio picked up by the microphones in each divided band, the directivity adjustment unit is allowed to adjust directivity and sharpness thereof in audio picked up by the microphones in each divided band based on the howling index in each band, and the howling suppression adjustment unit is allowed to adjust intensity of suppressing howling of audio picked up by the microphones in each divided band based on the howling index.

In the audio processing device, when the howling index is higher than a given threshold, the directivity adjustment unit may be allowed to perform adjustment so as to increase the directivity and sharpness thereof in audio picked up by the microphones based on the howling index, and the howling suppression adjustment unit may be allowed to perform adjustment so as to increase the intensity of suppressing howling in the audio picked up by the microphones based on the howling index when the intensity of directivity becomes maximum, and when the howling index is lower than the given threshold, the howling suppression adjustment unit may be allowed to perform adjustment so as to reduce the intensity of suppressing howling in the audio picked up by the microphones based on the howling index, and the directivity adjustment unit may be allowed to perform adjustment so as to reduce the intensity of directivity in the audio picked up by the microphones based on the howling index when the intensity of suppressing howling becomes minimum.

Another embodiment of the present disclosure is directed to an audio processing method of an audio processing device including adjusting directivity and sharpness thereof in audio picked up by plural microphones picking up audio, and adjusting intensity of suppressing howling of audio picked up by the plural microphones by the audio processing unit, in which, in the process of adjusting the directivity, the directivity and sharpness thereof are adjusted in preference to the howling suppression of audio performed by the process of adjusting howling suppression.

Still another embodiment of the present disclosure is directed to a program for allowing a computer controlling an audio processing device to execute processing including adjusting directivity and sharpness thereof in audio picked up by plural microphones picking up audio, and adjusting intensity of suppressing howling of audio picked up by the plural microphones, in which, in the process of adjusting the directivity, the directivity and sharpness thereof are adjusted in preference to the howling suppression of audio performed by the process of adjusting howling suppression.

According to the embodiments of the present disclosure, the directivity and sharpness thereof in audio picked up by plural microphones picking up audio are adjusted, the intensity of suppressing howling of audio picked up by the plural microphones is adjusted, and the directivity and sharpness thereof are adjusted in preference to the howling suppression of audio.

The audio processing device according to the embodiment of the present disclosure may be an independent device as well as a block which performs processing of audio.

According to the embodiments of the present disclosure, it is possible to reduce deterioration of tone quality while suppressing howling occurring when using the microphone and the speaker.

### BRIEF DESCRIPTION OF THE DRAWINGS

FIG. 1 is a block diagram showing a configuration example of an audio processing device to which a signal processing unit according to an embodiment of the present disclosure is applied;

FIG. 2 is a flowchart explaining howling suppression processing;

FIG. 3 is a view explaining fast Fourier transform;

FIG. 4 is a view explaining adjustment of directivity;

FIG. 5 is a flowchart explaining howling index calculation processing;

FIG. 6 is a view explaining the howling index calculation processing; and

FIG. 7 is a diagram explaining a configuration example of a general-purpose personal computer.

### DETAILED DESCRIPTION

### [Configuration Example of Signal Processing Unit]

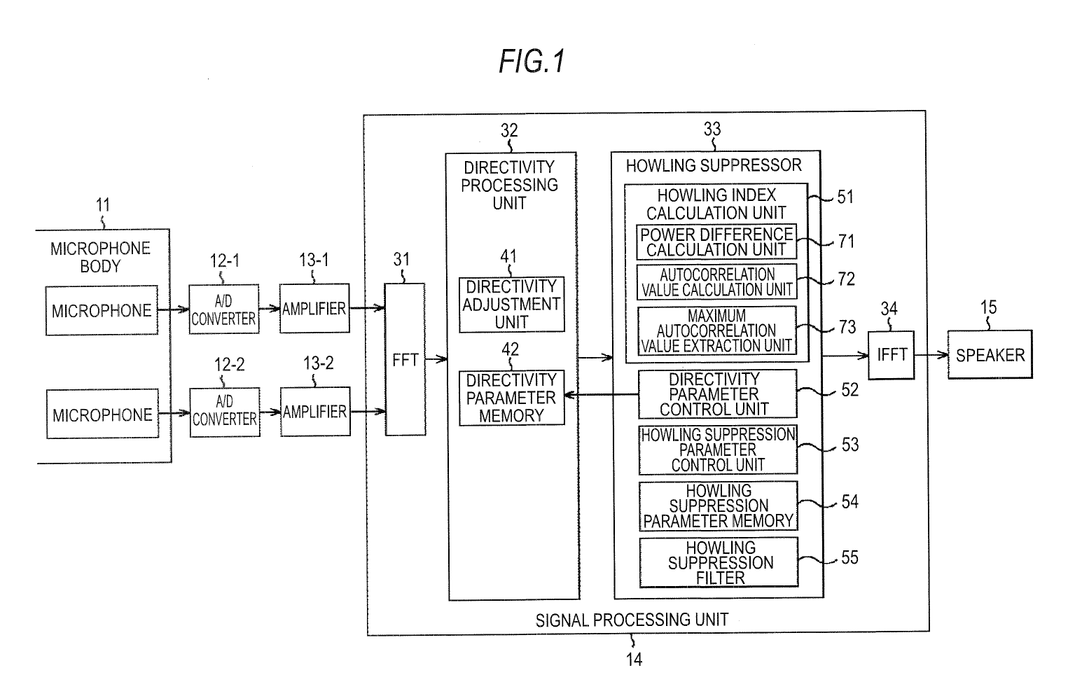

FIG. 1 shows a configuration example of an audio processing device to which a signal processing unit according to an embodiment of the present disclosure is applied. A signal processing unit 14 of FIG. 1 is a so-called DSP (Digital Signal Processor), receiving input of audio signals picked up by a microphone body 11, converted from analog signals to digital signals by A/D converters 12-1 and 12-2 and amplified by amplifiers 13-1 and 13-2. Then, the signal processing unit 14 performs signal processing to the inputted audio signals to thereby output audio from a speaker 15 while suppressing howling and reducing deterioration of tone quality.

More particularly, the microphone body 11 includes two microphones of microphones 10-1 and 10-2, picking up audio respectively and outputting audio signals as analog signals to the A/D converters 12-1 and 12-2. When it is not necessary to particularly distinguish respective microphones 10-1 and 10-2 from each other, they are merely referred to as microphones 10, and other configurations are referred to in the same manner. Though the example in which the microphone body 11 is provided with two microphones 10-1 and 10-2 is shown, two or more microphones 10 may be provided as long as a plurality of microphones 10 are provided.

The A/D (Analog/Digital) converters 12-1 and 12-2 converts analog audio signals supplied from respective microphones 10-1 and 10-2 of the microphone body 11 into digital audio signals and supplies the signals to the amplifiers 13-1 and 13-2.

The amplifiers 13-1 and 13-2 amplify the digital audio signals respectively and supplies the signals to the signal processing unit 14.

The signal processing unit 14 performs given signal processing to the supplied digital signals to be outputted from the speaker as audio.

In more detail, the signal processing unit 14 includes a FFT (Fast Fourier Transform) 31, a directivity processing unit 32, a howling suppressor 33 and an IFFT (Inverse Fast Fourier Transform) 34. The FFT 31 performs fast Fourier transform to the digital audio signal to thereby divide the signal into bands and supplies audio signals in respective bands to the directivity processing unit 32. That is, the FFT 31 performs Fourier transform by taking adjacent two samples as one frame in samples of the audio signal set in time series at given intervals, thereby calculating frequency spectra. Furthermore, the FFT 31 divides the audio signal into respective bands based on the frequency spectra calculated by Fourier transform, supplying the audio signals divided into respective bands to the directivity processing unit 32 with the frequency spectra.

Although the configuration in which one directivity processing unit 32 and one howling suppressor 33 are provided is shown in FIG. 1, they are provided with respect to respective bands and parallel processing is performed. Naturally, it is possible to apply the configuration in which one directivity processing unit 32 and one howling suppressor 33 are provided and time-sharing processing is performed to audio signals in respective bands.

The directivity processing unit 32 includes a directivity adjustment unit 41 and a directivity parameter memory 42. The directivity parameter memory 42 stores directivity parameters set by the housing suppressor 33 in units of bands. The directivity adjustment unit 41 adjusts directivity of the audio signal and intensity thereof in each band based on directivity parameters stored in the directivity parameter memory 42 in units of bands. The directivity processing unit 32 outputs the audio signal in which the directivity and sharpness thereof are adjusted in each band to the howling suppressor 33 with the frequency spectra.

The howling suppressor 33 calculates a howling index in each band based on the frequency spectra and the audio signals in respective bands in which directivity is adjusted supplied from the directivity processing unit 32. The howling suppressor 33 also sets the directivity parameter in each band based on the calculated howling index and stores the parameter in the directivity parameter memory 42 in the directivity processing unit 32. The howling suppressor 33 also suppresses howling of the audio signals in respective bands in which the directivity is adjusted supplied from the directivity processing unit 32 based on the housing indexes and supplies the signals to the IFFT 34.

The IFFT 34 combines the audio signals in which howling is suppressed in respective bands supplied from the howling suppressor 33 with the audio signals divided into respective bands by performing inverse fast Fourier transform and supplies the signal to the speaker 15 to be outputted as audio.

In more detail, the howling suppressor 33 includes a howling index calculation unit 51, a directivity parameter control unit 52, a howling suppression parameter control unit 53, a howling suppression parameter memory 54 and a howling suppression filter 55. Additionally, the howling index calculation unit 51 includes a power difference calculation unit 71, an autocorrelation value calculation unit 72 and a maximum autocorrelation value extraction unit 73, calculating the howling index in each band, which is a detection index of howling in the audio signal in which the directivity is processed. That is, the power difference calculation unit 71 calculates power difference between frames of the frequency spectrum with respect to each band. The autocorrelation value calculation unit 72 calculates autocorrelation in each band based on the power difference and normalizes the calculated autocorrelation, thereby calculating an autocorrelation value in each band. The maximum autocorrelation value extraction unit 73 extracts the maximum value of the autocorrelation values calculated as the above. The howling index calculation unit 51 outputs the maximum value in each band extracted by the maximum autocorrelation value extraction unit 73 as a calculation result of the howling index in each band.

The directivity parameter control unit 52 sets the directivity parameter in each band based on the howling index in each band and stores the set directivity parameter in each band in the directivity parameter memory 42 in the directivity processing unit 32. The directivity parameter is a parameter indicating sharpness of directivity in each band when the directivity is adjusted by the directivity adjustment unit 41. That is, when the howling index is higher than a given threshold and it is assumed that howling occurs, the directivity parameter control unit 52 sets a value whereby the level of the directivity and sharpness thereof is enhanced by a given level as the directivity parameter in each band.

The howling suppression parameter control unit 53 sets the howling suppression parameter in each band based on the howling index in each band, and stores the set howling suppression parameter in each band in the howling suppression parameter memory 54. The howling suppression parameter is a parameter indicating intensity of suppression at the time of suppressing howling by the howling suppression filter 55. That is, when the howling index is higher than a given threshold and it is assumed that howling occurs as well as when it is difficult to control the directivity more sharply than the present state, the howling suppression parameter control unit 53 sets a value whereby the intensity of suppression is enhanced by a given level as the howling suppression parameter in each band. The howling suppression filter 55 suppresses howling in each band with the intensity of a filter suppressing howling in accordance with the howling suppression parameter in each band stored in the howling suppression parameter memory 54.

That is, as the configuration for suppressing howling, the directivity processing unit 32 adjusting the directivity and sharpness thereof and the howling suppressor suppressing howling by applying the howling suppression filter are provided in the signal processing unit 14 with respect to each band. However, it is known that tone quality is deteriorated in the method of applying the howling suppression filter as compared with the method of adjusting directivity as described above. Therefore, when it is assumed that howling occurs based on the howling index in each band, first, the directivity and sharpness thereof are adjusted by the directivity processing unit 32 while changing the sharpness of directivity by a given level, then, when occurrence of howling is still not suppressed, the howling is suppressed by the howling suppression filter 55. As a result, it is possible to suppress the deterioration of tone quality while suppressing howling in the signal processing unit 14.

### [Howling Suppressing Processing]

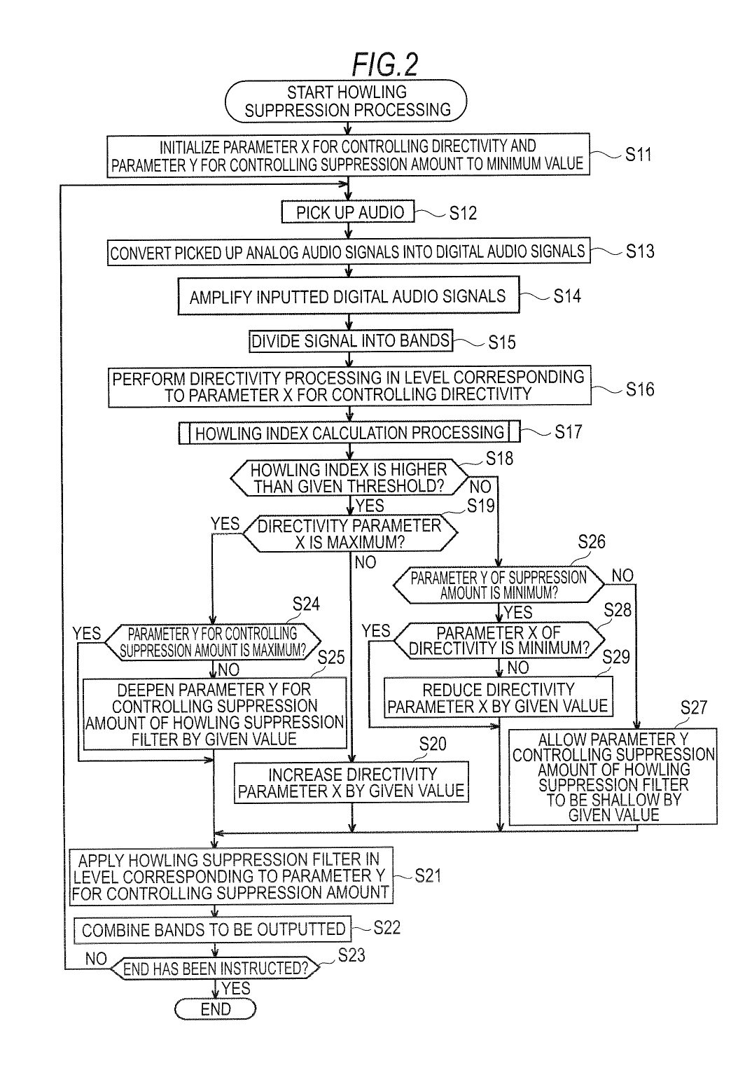

Next, howling suppression processing performed by the signal processing unit 14 of FIG. 1 will be explained with reference to a flowchart of FIG. 2.

In Step S11, the directivity parameter control unit 52 of the howling suppressor 33 sets a directivity parameter X to the minimum value, namely, an initial state in which the level of the directivity and sharpness thereof become minimum and the control is not actually performed, storing the parameter in the directivity parameter memory 42. Additionally, the howling suppression parameter control unit 53 sets a howling suppression parameter Y to the minimum value, namely, an initial state in which the intensity of suppression of the howling becomes minimum and the suppression is not actually performed, storing the parameter in the howling suppression parameter memory 54.

In Step S12, the microphones 10-1 and 10-2 of the microphone body 11 pickup audio respectively and output analog audio signals to the A/D converters 12-1 and 12-2.

In Step S13, the A/D converters 12-1 and 12-2 convert analog audio signals inputted from the microphone body 11 into digital audio signals respectively and output the signals to the amplifiers 13-1 and 13-2.

In Step S14, the amplifiers 13-1 and 13-2 amplify the inputted digital audio signals and output the signals to the signal processing unit 14.

In Step S15, the FFT 31 in the signal processing unit 14 performs fast Fourier transform by taking adjacent two samples as one frame in samples of the audio signals set in time series at given interval, thereby calculating frequency spectra. Furthermore, the FFT 31 divides the audio signal into respective bands based on the frequency spectra calculated by Fourier transform, supplying the audio signals divided into respective bands the directivity processing unit 32 with the frequency spectra.

That is, the FFT 31 performs fast Fourier transform to the inputted audio signal (inputted audio) into signals in frequency areas in units of frames as unit times. The FFT 31 also divides the audio signals to which fast Fourier transform has been performed in the frequency areas into plural bands, outputting audio signals in respective bands.

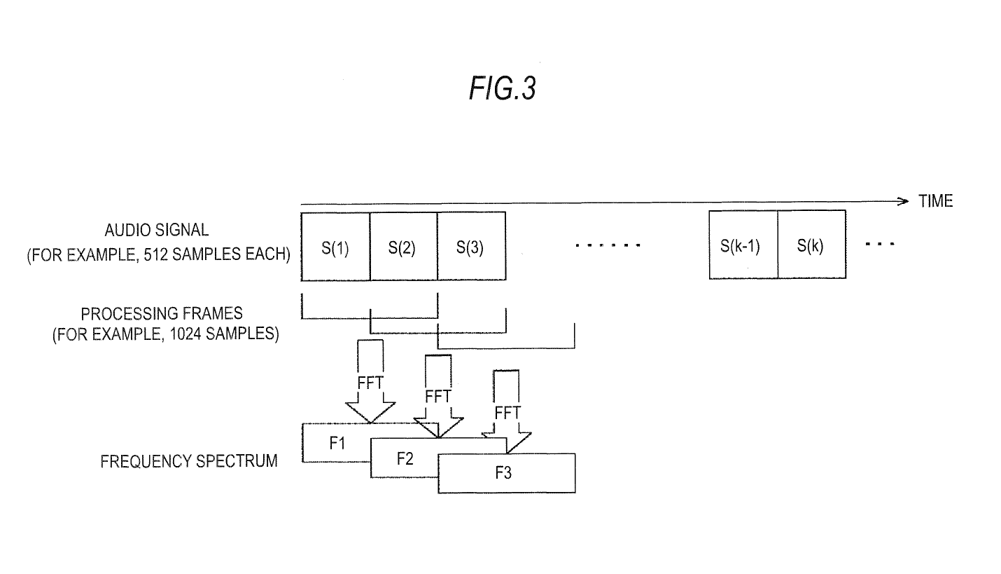

In more detail, for example, when the audio signal includes, for example, samples S(1), S(2), S(3), . . . S(n) as shown in the uppermost row of FIG. 3 with 512 samples each, the FFT 31 performs fast Fourier transform by using adjacent two samples S(n). According to the processing, when fast Fourier transform is performed to both samples S(1) and S(2) as shown in the second row of FIG. 3, a frequency spectrum F (1) is acquired as shown in the third row of FIG. 3. Similarly, when fast Fourier transform is performed to both samples S(2) and S(3), a frequency spectrum F (2) is acquired. Accordingly, processing frames as processing units in the FFT 31 will be two-samples each, that is, 1024 samples.

The band division may be performed by other well-known technologies as long as the audio signal is divided into plural bands.

In Step S16, the directivity adjustment unit 41 of the directivity processing unit 32 reads the directivity parameter X stored in the directivity parameter memory 42 in units of frequency bands and adjusts the directivity and sharpness thereof in each frequency band in accordance with the read directivity parameter X. Then, the directivity adjustment unit 41 outputs the audio signal in which the directivity has been adjusted in each frequency band to the howling suppressor 33.

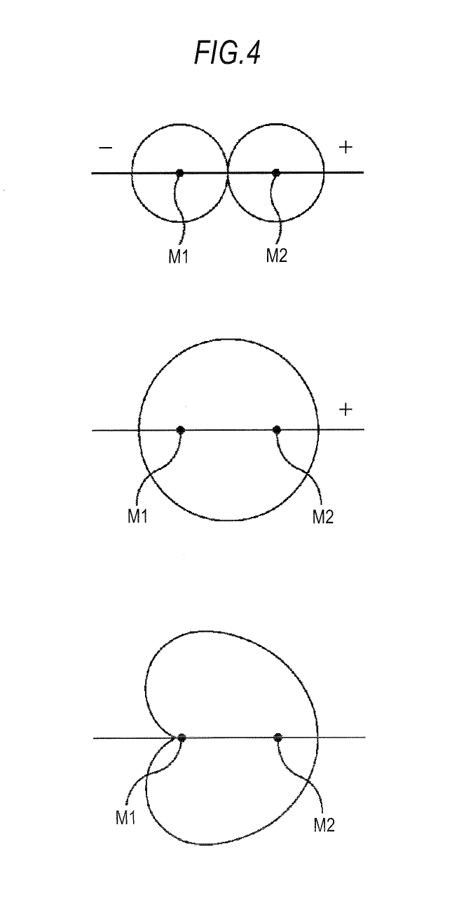

In more detail, the directivity adjustment unit 41 creates blind spots with respect to a speaker direction, for example, based on audio picked up by the microphones 10-1 and 10-2 respectively. That is, when the microphones 10-1 and 10-2 are set, for example, in positions M1 and M2 as shown in the top row of FIG. 4, the microphones 10-1 and 10-2 are set in the microphone body 11 so that the position M2 will be a position close to a speaking person as a sound source and the position M1 will be a position apart from the speaking person as the sound source. Then, the directivity adjustment unit 41 calculates a difference signal and a sum signal corresponding to purpose directions of the audio signals in respective frequency bands. At this time, for example, when a horizontal direction in the drawing, that is, a front direction and a back direction in the case where the speaking person holds the microphone body 11 are purpose directions, the difference signal is represented by two circular distributions in solid lines shown in the top row of FIG. 4 and the sum signal is represented by one circular distribution in a solid line shown in the middle row of FIG. 4. Note that “+” and “−” shown in FIG. 4 represent addition and subtraction of the audio signals of the microphones 10-1 and 10-2 corresponding to the positions M1 and M2. The directivity adjustment unit 41 adjusts the directivity by adding the difference signal and the sum signal after multiplying these signals by a coefficient in accordance with the directivity parameter X. That is, when the difference signal shown in the top row of FIG. 4 and the sum signal shown in the middle row of FIG. 4 are added after multiplying these signals by the coefficient respectively, the directivity adjustment unit 41 can form a distribution of a cardioid curve as shown in the lower row of FIG. 4. In the case shown in the lower row of FIG. 4, the directivity is formed, in which audio is not outputted in the left direction from the position M1 in the drawing. The difference signal and the sum signal set so as to correspond to purpose directions are added after multiplying these signals by the coefficient corresponding to the directivity parameter X as described above, thereby adjusting the directivity and sharpness thereof. It is possible to apply methods other than the method shown in FIG. 4 as long as the directivity and sharpness thereof can be adjusted, which are, for example, a delay-sum method, a 3-microphone integration method, an adaptive beamformer and the like.

In Step S17, the howling index calculation unit 51 of the howling suppressor 33 executes howling index calculation processing based on the audio signal supplied from the directivity processing unit 32, thereby calculating the howling index showing the degree of howling.

### [Howling Index Calculation Processing]

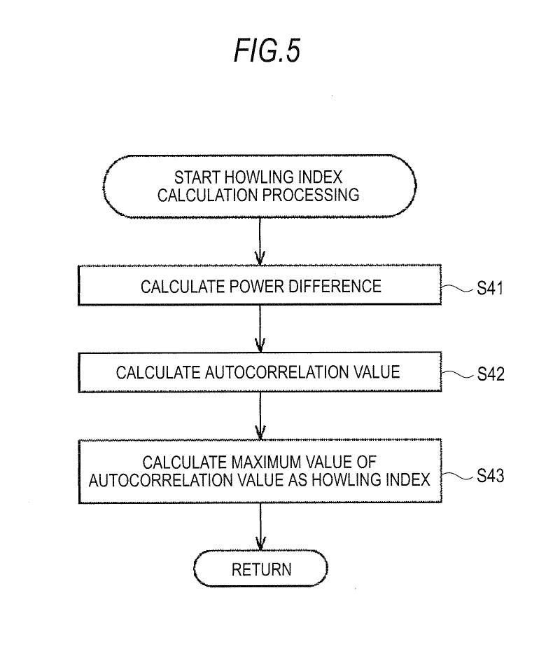

Here, the howling index calculation processing will be explained with reference to a flowchart of FIG. 5.

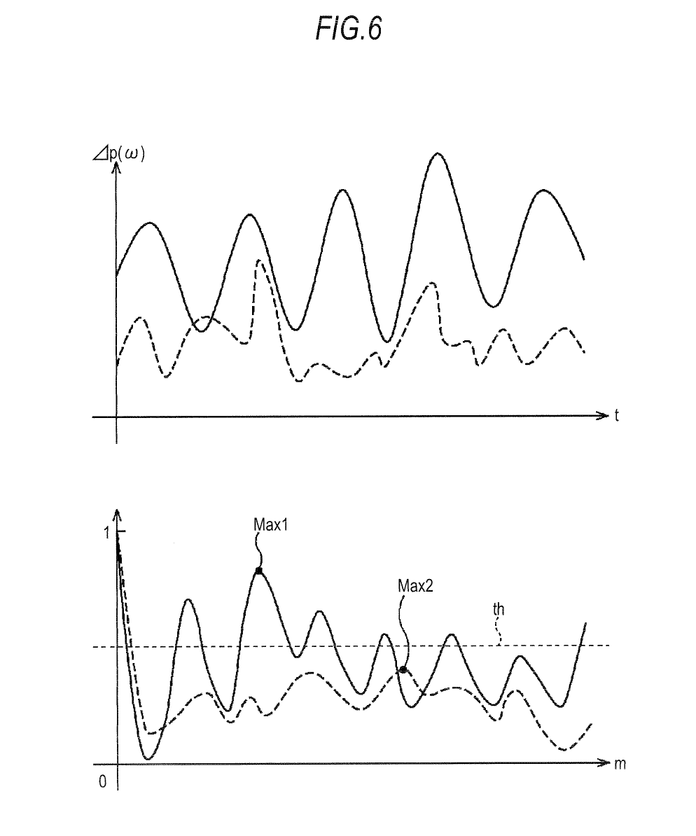

In Step S41, the howling index calculation unit 51 controls the power difference calculation unit 71 to calculate power difference between frames in respective frequency bands from the audio signals in respective frequency bands supplied from the directivity processing unit 32. That is, the power difference calculation unit 71 calculates power difference Δp(ω) in each band component by the frequency spectra F1(1), F(2), F(3), . . . F(n) shown in FIG. 3. Here, “ω” represents the frequency band. In this case, the power difference Δp(ω) calculated with respect to a certain particular frequency ω has a waveform shown in the upper row of FIG. 6.

In the waveforms of FIG. 6, a vertical axis represents power difference Δp (ω) and a horizontal axis represents a time direction “t”. A waveform shown by a solid line is a waveform obtained when it is assumed that howling occurs and a waveform shown by a dotted line is a waveform obtained when it is assumed that howling does not occur.

In Step S42, the howling index calculation unit 51 controls the autocorrelation value calculation unit 72 to calculate an autocorrelation value in each frequency band. Here, the autocorrelation value is a value indicating consistency between a signal itself and a signal shifted in the time direction by a given period of time. More specifically, the autocorrelation value calculation unit 72 calculates autocorrelation by calculating the following expression (1).

$${r}_{m} ( ω ) = {{\sum }_{r}}^{N} Δ p ( ω , t ) \times Δ p ( ω , t + m ) m = 1 , … , N \qquad ( 1 )$$

Here, Δp(ω, t) represents power difference when the frequency band is ω and the time is “t”. In the expression, “m” represents an integer of 1 to N representing the number of points indicating the shift amount and rm(ω) represents autocorrelation.

The autocorrelation is useful for searching for a repetition pattern included in the signal, which is used for determining, for example, the presence of a periodic signal buried in noise. In the autocorrelation, a higher value is taken when there is periodicity and a lower value is taken when there is not periodicity. The autocorrelation is high when howling occurs as the power difference Δp(ω, t) has periodicity, and the autocorrelation is low when it is assumed that howling does not occur as the power difference Δp(ω, t) does not have periodicity.

Furthermore, the autocorrelation value calculation unit 72 applies the following expression (2) with respect to respective bands ω to thereby calculate the autocorrelation value by normalizing the autocorrelation rm(ω) by using autocorrelation r0(ω) in which the shift amount “m” is “0”.

$$Ev = \vert \frac{{r}_{m} ( ω )}{{r}_{o} ( ω )} \vert \qquad ( 2 )$$

Here, Ev represents the autocorrelation value. That is, the autocorrelation value Ev is calculated as an absolute value obtained by normalizing the autocorrelation rm(ω) by using r0(ω). The autocorrelation is normalized as described above, it becomes easy to determine whether howling occurs or not.

That is, in the lower row of FIG. 6 autocorrelation values acquired from the power difference Δp(ω) shown in the upper row of FIG. 6 are shown. In the lower row of FIG. 6, a vertical axis represents the autocorrelation value and a horizontal axis represents the shift amount “m”. A waveform shown by a solid line is a waveform obtained when it is assumed that howling occurs and a waveform shown by a dotted line is a waveform obtained when it is assumed that howling does not occur. As shown by the solid-line waveform, when it is assumed that howling occurs, the autocorrelation value Ev periodically varies in accordance with variation of the shift amount “m”. On the other hand, as shown by the dotted-line waveform, when it is assumed that the howling does not occur, the autocorrelation value Ev is assumed not to have periodicity with respect to variation of the shift amount “m”.

In Step S43, the howling index calculation unit 51 controls the maximum autocorrelation value extraction unit 73 to extract the maximum value of the autocorrelation value Ev in each frequency band to set the extracted maximum value of the autocorrelation value as a howling index in each frequency band.

For example, in the case of the autocorrelation value Ev shown by the lower row of FIG. 6, the maximum autocorrelation value extraction unit 73 extracts the maximum values Max1 and Max2. That is, when it is assumed that the howling occurs, the maximum value Max1 of the autocorrelation value Ev is extracted, and when it is assumed that the howling does not occur, the maximum value Max2 of the autocorrelation value Ev is extracted, which are respectively set as howling indexes. When it is assumed that the howling occurs, the autocorrelation value Ev shows a greater amplitude as the autocorrelation rm(ω) is higher, therefore, the howling index is increased. On the other hand, when it is assumed that the howling does not occur, the autocorrelation value Ev shows a smaller amplitude as the autocorrelation rm(ω) is lower, therefore, the howling index is reduced. Accordingly, it is possible to determine whether the howling occurs or not by determining whether the howling index is higher than a given threshold or not.

Here, let us return to explanation of the flowchart of FIG. 2.

After the howling index calculation processing in Step S17 is executed and the howling index is calculated, the howling suppressor 33 determines whether the howling index is higher than the given threshold and the howling is assumed to occur or not in each band in Step S18.

When the howling index is the maximum value Max1, for example, as shown in the lower row of FIG. 6 in Step S17, the howling index is higher than a given threshold “th”, therefore, the howling suppressor 33 determines that howling occurs, then, the process proceeds to Step S19.

In Step S19, the directivity parameter control unit 52 reads the directivity parameter X stored in the directivity parameter memory 42 in each band in which howling is assumed to occur. Then, the directivity parameter control unit 52 determines whether the directivity parameter X is the maximum value and it is difficult to control the howling by adjusting the directivity and sharpness thereof anymore or not in each band in which the howling is assumed to occur. When it is determined that the directivity parameter X is not the maximum value and it is possible to suppress the howling by enhancing and adjusting the directivity and sharpness thereof in Step S19, the process proceeds to Step S20.

In Step S20, the directivity parameter control unit 52 reads the directivity parameter X stored in the directivity parameter memory 42 and increases the directivity parameter X by a given value to update the directivity parameter X in the directivity parameter memory 42. That is, the directivity parameter control unit 52 increases the level of howling suppression by the directivity and sharpness thereof.

In Step S21, the howling suppression filter 55 reads the howling suppression parameter stored in the howling suppression parameter memory 54 on a band basis and applies the howling suppression filter on a band basis to be supplied to the IFFT 34.

In Step S22, the IFFT 34 combines the audio signals to which the howling suppression filter processing has been performed in units of bands by performing inverse fast Fourier transform, outputting the signals from the speaker 15 as audio.

In Step S23, the signal processing unit 14 determines whether a not-shown operation unit has been operated and end of the howling suppression processing has been instructed or not. For example, when the not-shown operation unit has been operated and end of the howling suppression processing has been instructed in Step S23, the process ends. When end has not been instructed, the process proceeds to Step S12.

On the other hand, when it is determined that the directivity parameter X is the maximum value in Step S19, the process proceeds to Step S24.

In Step S24, the howling suppression parameter control unit 53 reads the howling suppression parameter Y stored in the howling suppression parameter memory 54 and determines whether the howling suppression parameter Y is the maximum value or not. That is, whether the howling suppression parameter Y is the maximum value and it is difficult to suppress the howling anymore by the howling suppression filter 55 or not is determined.

For example, when it is determined that the howling suppression parameter Y is not the maximum value in Step S24, the howling suppression parameter control unit 53 increases the howling suppression parameter Y by a given value to enhance (deepen) the suppression level of howling in Step S25. Then, the process proceeds to Step S21. That is, when it is assumed that howling occurs, first, whether the directivity parameter X is the maximum and the level in which howling can be suppressed by adjusting the directivity and sharpness thereof by application is the maximum or not is determined, then, when it is determined that the above level is the maximum, the deepness of howling suppression is deepened by a given value in the case where the suppression of howling by the howling suppression filter 55 is possible.

Also in Step S24, when it is determined that the howling suppression parameter Y is the maximum value, the process of Step S25 is skipped.

Furthermore, when the howling index is Max 2 shown in the lower row of FIG. 6 and is lower than the given threshold “th”, and it is assumed that the howling does not occur in Step S18, the process proceeds to Step S26.

In Step S26, the howling suppression parameter 53 reads the howling suppression parameter Y stored in the howling suppression parameter memory 54 and determines whether the howling suppression parameter Y is the minimum value or not. That is, whether the howling suppression parameter Y is not the minimum value and it is difficult to reduce the level of howling suppression by the howling suppression filter 55 anymore or not is determined. For example, when the howling suppression parameter Y is not the minimum value in Step S26, that is, it is determined that the level of howling suppression by the howling suppression filter 55 can be reduced more, the process proceeds to Step S27.

In Step S27, the howling suppression parameter control unit 53 reduces the howling suppression parameter Y by a given value to allow the level of howling suppression to be shallow by a given level. Then, the process proceeds to Step S21. That is, when it is not assumed that the howling occurs, first, the deepness of suppressing the howling is allowed to be shallow by the given level when it is possible to reduce the level of howling suppression by the howling suppression filter for improving tone quality.

In Step S26, for example, when the howling suppression parameter Y is the minimum value, that is, it is determined that it is difficult to reduce the level of howling by the howling suppression filter 55 anymore, the process proceeds to Step S28.

In Step S28, the directivity parameter control unit 52 reads the directivity parameter X stored in the directivity parameter memory 42 on a band basis in which howling is assumed not to occur. Then, the directivity parameter control unit 52 determines whether the directivity parameter X is the minimum value and it is difficult to reduce the level of howling suppression by adjusting the directivity and sharpness thereof anymore or not in each band in which the howling is assumed not to occur. When it is determined that the directivity parameter X is not the minimum value and it is possible to reduce the level of howling suppression by adjusting the directivity and sharpness thereof in Step S28, the process proceeds to Step S29.

In Step S29, the directivity parameter control unit 52 reads the directivity parameter X stored in the directivity parameter memory 42, reducing the parameter X by the given value to update the directivity parameter X in the directivity parameter memory 42. That is, the directivity parameter control unit 52 reduces the level of howling suppression by directivity. Then, the process proceeds to Step S21.

When it is determined that the directivity parameter X is the minimum value and it is difficult to reduce the level of howling suppression by adjusting the directivity anymore in Step S28, the process of Step S29 is skipped.

Then, the processes from Step S2 to Step S29 are repeated until the end is instructed in Step S23. When it is assumed that howling occurs based on the howling index, first, the directivity and sharpness thereof are adjusted by the directivity processing unit 32, and the level of directivity adjustment is increased until it is determined that the howling does not occur. In the process, when it is determined that it is difficult to suppress the howling even when the level of adjusting directivity and sharpness thereof is increased more, the same processing is repeated while gradually deepening the suppression level by the howling suppression filter 55 until it is assumed that howling does not occur.

That is, the adjustment of directivity in which deterioration of tone quality is relatively small is preferentially performed when it is assumed that howling occurs, and the suppression of howling by the howling suppression filter 55 in which deterioration of tone quality is relatively large is performed when it is difficult to reduce the howling by adjusting the directivity and sharpness thereof anymore.

Additionally, when it is assumed that howling does not occur and when the reduction of howling by the howling suppression filter has been performed, the suppression level of the howling suppression filter in which deterioration of tone quality is relatively large is preferentially allowed to be gradually shallow. In the process, when the suppression level by the howling suppression filter is the minimum and it is assumed that howling does not occur, subsequently, the level of howling suppression by adjustment of the directivity and sharpness thereof in which the deterioration of tone quality is assumed to be smaller is gradually reduced.

As the above howling suppression processing is executed, the howling is preferentially suppressed by the adjustment of directivity in each band in which the deterioration of tone quality is assumed to be relatively small, and when it is difficult to suppress the occurrence of howling by the adjustment of directivity, the howling suppression filter in which the deterioration of tone quality is assumed to be large is used. Additionally, when it is determined that howling does not occur, the suppression level of the howling suppression filter in which deterioration of tone quality is assumed to be large is preferentially reduced in units of bands, and when the suppression level of the howling suppression filter is minimum, suppression of the occurrence of howling by the adjustment of directivity in which deterioration of tone quality is assumed to be relatively small is performed.

Consequently, at the time of reducing howling, the suppression level by using the howling suppression filter in which deterioration of tone quality is assumed to be large is reduced and the directivity and sharpness thereof in which deterioration of tone quality is assumed to be relatively small is adjusted, thereby reducing the howling as much as possible, as a result, the deterioration of tone quality can be reduced while reducing the howling. Additionally, the howling is reduced by selecting only the band in which howling occurs by using the howling index calculated on a band basis in the above method, therefore, it is possible to reduce howling while minimizing deterioration of tone quality.

Incidentally, the above series of processing can be executed by hardware as well as software. When the series of processing is executed by software, programs included in the software are installed from recording media to a computer incorporated in dedicated hardware or, for example, a general-purpose computer capable of executing various functions by installing various programs.

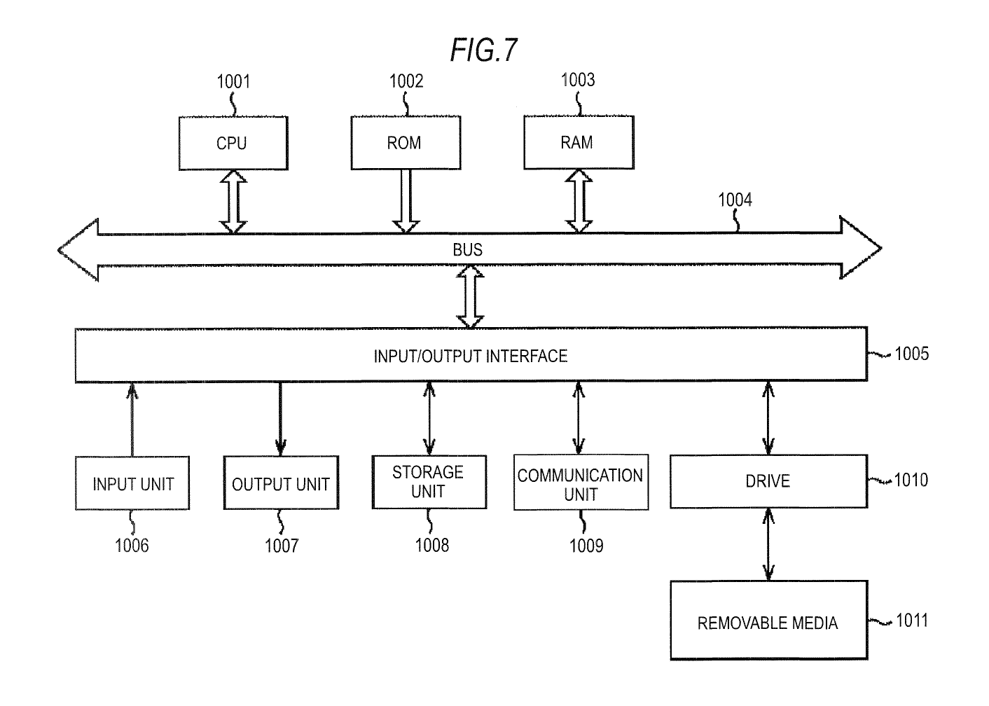

FIG. 7 shows a configuration example of a general-purpose personal computer. The personal computer includes a CPU (Central Processing unit) 1001. An input/output interface 1005 is connected to the CPU 1001 through a bus 1004. A ROM (Read Only Memory) 1002 and a RAM (Random Access Memory) 1003 are connected to the bus 1004.

An input unit 1006 including input devices such as a keyboard and a mouse whereby a user inputs operation commands, an output unit 1007 outputting a processing operation screen and images of processing results to a display device, a storage unit 1008 including a hard disk drive and so on, which stores programs and various data and a communication unit 1009 including a LAN (Local Area Network) adaptor and so on, which executes communication processing through networks typified by Internet are connected to the input/output interface 1005. Also, a drive 1010 reading and writing data with respect to removable media 1011 such as a magnetic disc (including a flexible disc), an optical disc (including CD-ROM (Compact Disc-Read Only Memory), a DVD (Digital Versatile Disc)), a magneto-optic disc (including a MD (Mini Disc)) and a semiconductor memory is connected to the input/output interface 1005.

The CPU 1001 executes various processing in accordance with programs stored in the ROM 1002, or programs read from the removable media 1011 such as the magnetic disc, the optical disc or the semiconductor memory, installed in the storage unit 1008 and loaded from the storage unit 1008 to the RAM 1003. Also in the RAM 1003, data necessary for executing various processing and so on by the CPU 1001 are appropriately stored.

In the computer configured as the above, the above series of processing is performed the CPU 1001 loading programs stored in, for example, the storage unit 1008 to the RAM 1003 through the input/output interface 1005 and the bus 1004 and executing the programs.

The programs executed by the computer (CPU 1001) can be provided, for example, by being recorded in the removable media 1011 as package media and so on. The programs can be also provided through wired or wireless transmission media such as local area networks, Internet and digital satellite broadcasting.

In the computer, programs can be installed in the storage unit 1008 through the input/output interface 1005 by mounting the removal media 1011 on the drive 1010. The programs also can be installed in the storage unit 1008 by being received by the communication unit 1009 through wired or wireless transmission media. Additionally, the programs can be installed in advance in the ROM 1002 or the storage unit 1008.

Programs executed by the computer may be programs processed in time series along the order explained in the specification, programs processed in parallel, or programs processed at necessary timing such as when calling is performed.

In the specification, a system means an aggregate of plural components (devices, modules (parts) and so on), and it is not always necessary that all components are included in the same casing. Therefore, both plural devices housed in separate casings and connected through a network and one device housing plural modules in one casing are called a system.

The embodiment of the present disclosure is not limited to the above described embodiment, and various modifications may occur within a range not departing from the gist of the present disclosure.

For example, the present disclosure may apply a configuration of cloud computing in which one function is shared among plural devices through a network and processed in cooperation with one another.

Additionally, respective steps explained in the above flowcharts can be executed not only by being executed by one device but also by being shared among plural devices.

Furthermore, when plural processes are included in one step, plural processes included in one step can be executed not only by one device but also can be shared among and executed by plural devices.

The present disclosure may be implemented as the following configurations.

(1) An audio processing device including

a directivity adjustment unit adjusting directivity and sharpness thereof in audio picked up by plural microphones picking up audio, and

a howling suppression adjustment unit adjusting intensity of suppressing howling of audio picked up by the plural microphones,

in which the directivity adjustment unit adjusts the directivity and sharpness thereof in preference to the howling suppression of audio performed by the howling suppression adjustment unit.

(2) The audio processing device described in the above (1), further including

a howling index calculation unit calculating a howling index indicating an index of howling occurring due to audio picked up by the plural microphones,

in which the directivity adjustment unit adjusts directivity and sharpness thereof in audio picked up by the plural microphones picking up audio based on the howling index, and

the howling suppression adjustment unit adjusts intensity of suppressing howling of audio picked up by the plural microphones based on the howling index.

(3) The audio processing device described in the above (1) or (2), further including

a band division unit dividing a band of audio picked up by the microphones,

in which the howling suppression adjustment unit calculates the howling index indicating the index of howling occurring due to audio picked up by the microphones in each divided band,

the directivity adjustment unit adjusts directivity and sharpness thereof in audio picked up by the microphones in each divided band based on the howling index in each band, and

the howling suppression adjustment unit adjusts intensity of suppressing howling of audio picked up by the microphones in each divided band based on the howling index.

(4) The audio processing device described in any of the above (1) to (3),

in which, when the howling index is higher than a given threshold, the directivity adjustment unit performs adjustment so as to increase the directivity and sharpness thereof in audio picked up by the microphones based on the howling index, and the howling suppression adjustment unit performs adjustment so as to increase the intensity of suppressing howling in the audio picked up by the microphones based on the howling index when the intensity of directivity becomes maximum, and

when the howling index is lower than the given threshold, the howling suppression adjustment unit performs adjustment so as to reduce the intensity of suppressing howling in audio picked up by the microphones based on the howling index, and the directivity adjustment unit performs adjustment so as to reduce the intensity of directivity in the audio picked up by the microphones based on the howling index when the intensity of suppressing howling becomes minimum.

(5) An audio processing method of an audio processing device including

adjusting directivity and sharpness thereof in audio picked up by plural microphones picking up audio, and

adjusting intensity of suppressing howling of audio picked up by the plural microphones by the audio processing unit,

in which, in the process of adjusting the directivity, the directivity and sharpness thereof are adjusted in preference to the howling suppression of audio performed by the process of adjusting howling suppression.

(6) A program for allowing a computer controlling an audio processing device to execute processing including

adjusting directivity and sharpness thereof in audio picked up by plural microphones picking up audio, and

adjusting intensity of suppressing howling of audio picked up by the plural microphones,

in which, the process of adjusting the directivity, the directivity and sharpness thereof are adjusted in preference to the howling suppression of audio performed by the process of adjusting howling suppression.

The present disclosure contains subject matter related to that disclosed in Japanese Priority Patent Application JP 2012-107856 filed in the Japan Patent Office on May 9, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An audio processing device comprising:
a directivity adjustment unit adjusting directivity and sharpness thereof in audio picked up by plural microphones picking up audio; and
a howling suppression adjustment unit adjusting intensity of suppressing howling of audio picked up by the plural microphones,
wherein the directivity adjustment unit adjusts the directivity and sharpness thereof in preference to the howling suppression of audio performed by the howling suppression adjustment unit.

2. The audio processing device according to claim 1, further comprising:
a howling index calculation unit calculating a howling index indicating an index of howling occurring due to audio picked up by the plural microphones,
wherein the directivity adjustment unit adjusts directivity and sharpness thereof in audio picked up by the plural microphones picking up audio based on the howling index, and
the howling suppression adjustment unit adjusts intensity of suppressing howling of audio picked up by the plural microphones based on the howling index.

3. The audio processing device according to claim 2, further comprising:
a band division unit dividing a band of audio picked up by the microphones,
wherein the howling suppression adjustment unit calculates the howling index indicating the index of howling occurring due to audio picked up by the microphones in each divided band,
the directivity adjustment unit adjusts directivity and sharpness thereof in audio picked up by the microphones in each divided band based on the howling index in each band, and
the howling suppression adjustment unit adjusts intensity of suppressing howling of audio picked up by the microphones in each divided band based on the howling index.

4. The audio processing device according to claim 2,
wherein, when the howling index is higher than a given threshold, the directivity adjustment unit performs adjustment so as to increase the directivity and sharpness thereof in audio picked up by the microphones based on the howling index, and the howling suppression adjustment unit performs adjustment so as to increase the intensity of suppressing howling in the audio picked up by the microphones based on the howling index when the intensity of directivity becomes maximum, and
when the howling index is lower than the given threshold, the howling suppression adjustment unit performs adjustment so as to reduce the intensity of suppressing howling in the audio picked up by the microphones based on the howling index, and the directivity adjustment unit performs adjustment so as to reduce the intensity of directivity in the audio picked up by the microphones based on the howling index when the intensity of suppressing howling becomes minimum.

5. An audio processing method of an audio processing device comprising:
adjusting directivity and sharpness thereof in audio picked up by plural microphones picking up audio; and
adjusting intensity of suppressing howling of audio picked up by the plural microphones by the audio processing unit,
wherein, in the process of adjusting the directivity, the directivity and sharpness thereof are adjusted in preference to the howling suppression of audio performed by the process of adjusting howling suppression.

6. A program for allowing a computer controlling an audio processing device to execute processing, comprising:
adjusting directivity and sharpness thereof in audio picked up by plural microphones picking up audio; and
adjusting intensity of suppressing howling of audio picked up by the plural microphones,
wherein, in the process of adjusting the directivity, the directivity and sharpness thereof are adjusted in preference to the howling suppression of audio performed by the process of adjusting howling suppression.
